(19) United States
(12) Patent Application Publication
(10) Pub. No.: US 2019/0023951 A1
(43) Pub. Date: Jan. 24, 2019

(54) BARRIER COATING FOR ADHESIVE LABELS

(71) Applicant: CCL LABEL, INC., Framingham, MA (US)

(72) Inventors: Frank Yen-Jer Shih, Arcadia, CA (US); Anahit Tataryan, Eastvale, CA (US); William Joseph Buehne, Highland, IN (US)

(21) Appl. No.: 16/039,633

(22) Filed: Jul. 19, 2018

Related U.S. Application Data
(60) Provisional application No. 62/534,427, filed on Jul. 19, 2017.

(51) Int. Cl. C09J 7/50; C09J 7/21; C09J 7/38; C09J 7/40; C09J 11/06

(52) U.S. Cl. CPC C09J 7/50; C09J 7/21; C09J 7/38; C09J 7/40; C09J 11/06; C09J 2429/001; C09J 2433/001; C09J 2431/001; C09J 2475/001; C09J 2409/001; C09J 2203/334

(57) ABSTRACT

A barrier coating is used in combination with a UV-cured adhesive on paperstock to prolong the tack and overall performance of the adhesive. Some aspects of the coating incorporate a chelating material to arrest or completely prevent the migration of unwanted ions, possibly including calcium ions, from moving between the paperstock and the adhesive in a manner that negatively impacts the adhesive. The resulting stock is particularly well-suited to labels and other similar uses.

### CROSS REFERENCE TO RELATED APPLICATIONS

This application claims priority to U.S. Provisional Patent Application Ser. No. 62/534,427 filed on Jul. 19, 2017, which is incorporated by reference herein.

### FIELD OF INVENTION

The present disclosure generally relates to a coating composition, method, and laminate for label applications having improved longevity and performance. More specifically, a barrier layer having a composition to extend the life of the adhesive is described.

### BACKGROUND

Barrier layers have been disclosed in the prior art to prevent the unwanted migration of certain components through a film or label. Usually, these disclosures rely on an intervening layer provided within the film/label from penetrating and, therefore, migrating through the adhesive and into the facestock of the film, label, or other substrate. In this manner, the life and utility of the overall structure is preserved and extended.

U.S. Pat. No. 3,632,424 discloses an interpolymer lattice structure of ethylene, vinyl chloride and acrylamide, with or without small quantities of other monomers. The disclosed lattice can serve as free standing film and for coating fibrous substrates, such as paper, fabric, and the like.

U.S. Pat. No. 5,891,294 discloses a barrier layer of polyamide or polyurethane. The layer is located above a substrate or base layer and between an ultraviolet topcoat layer and a vinyl wear layer. The disclosed barrier layer is disposed on a surface covering such as vinyl flooring and helps to prevent the diffusion of stains (e.g., plasticizers, dyes, etc.) onto the surface adjacent to the barrier layer.

U.S. Pat. No. 6,235,363 discloses a composite laminate for use as a label or adhesive tape applied to rubber-based substrates, such as vehicle tires. The laminate includes a first substrate composed of paper and/or polymer film and a barrier layer of cross linked cycloaliphatic epoxide, polyol(s), and a photoinitiator positioned between the underside of the first substrate and an adhesive layer. A release liner may be disposed on the opposing side of the adhesive layer. The barrier layer in this arrangement is substantially impervious to migratory components in the adhesive and/or rubber-based substrate.

U.S. Pat. No. 7,141,285 also discloses a laminate for use as a label or adhesive tape applied to rubber-based substrates, such as vehicle tires. The laminate includes a first substrate composed of paper and/or polymer film and a barrier of acrylated epoxy derived from N-vinyl-2-pyrrolidine and/or N-vinylcaprolactam. A release liner may be disposed on the opposing side of the adhesive layer. The barrier layer in this arrangement is substantially impervious to migratory components in the adhesive and/or rubber-based substrate.

United States Patent Publication 2009/0136773 relies on an acrylic core shell polymer or an organic perfluorochemical to serve as a barrier layer in label stock. The resulting label prevents absorption of the adhesive by the label stock and reduces the amount of adhesive needed in order to achieve sufficient peel force.

While barrier layers are known and generally serve to prevent migration of the adhesive from its intended position into the facestock of the label (i.e., the paper or polymeric film), a label is needed to help preserve the longevity of the adhesive itself. That is, rather than merely preventing migration of the adhesive, a barrier layer that is capable of preventing the degradation of the adhesive layer would be welcome.

### SUMMARY

An ultraviolet (UV) activated adhesive is coated onto facestock. A barrier layer, including an ionic migratory retardant and optional amounts of binder and/or pigmented coating/ink, is disposed between the UV-coating and the facestock. The resulting labels provide unexpected durability and resistance to loss of tack even after high temperature-high humidity storage for two weeks.

In one aspect, a sheet, label, or other article capable of being selectively adhered to an object is contemplated and includes any combination of the following:
an adhesive layer cured with ultraviolet radiation;
a substrate layer positioned on an outer facing of the sheet, said substrate layer containing at least one multi-valent ionic species which migrates out of the substrate layer;
a barrier layer interposed between the adhesive layer and the substrate layer at all points where the adhesive layer would otherwise come into direct physical contact with the substrate layer, said barrier layer including a substance to apprehend migration of the multi-valent ionic species before the multi-valent ionic species comes into contact with the adhesive layer;
wherein the multi-valent ionic species includes calcium ions;
wherein the substance is chelating agent;
wherein the substance is a hydrophobic polymer;
wherein the substance consists of at least one selected from an acrylic or acrylic copolymer (e.g., styrene acrylic copolymer) emulsion, a polyethylene waxed-based emulsion, an ethylenediaminetetraacetic acid or a derivative thereof, a polyfunctional aziridine-based cross linker, a polyurethane emulsion, a carboxylated styrene butadiene rubber or non-carboxylated styrene butadiene rubber emulsion, and a polyvinyl acetate or polyvinyl acetate copolymer (e.g., poly(vinyl alcohol) stabilized vinyl acetate-ethylene) emulsion;
wherein the barrier layer is formulated to consist of between 5 and 25 wt. % of water;
wherein the barrier layer is formulated with de-ionized water;
wherein the barrier layer is coated at a weight of between 2.5 and 10.0 grams per square meter;
wherein the barrier layer is coated at a weight of greater than 5.0 grams per square meter;
wherein the substrate layer consists of paperstock having a multi-valent ionic species;
wherein the sheet includes at least one of: a pigment and an ink activated by ultraviolet radiation;
wherein a release liner is applied to the adhesive layer;
wherein the barrier layer is applied directly to the substrate layer; and
wherein the barrier layer is partially or intermittently applied to only portions of the sheet.

In another aspect, a method of prolonging a functional lifespan for an adhesive label cured by ultraviolet radiation is contemplated. This method may include any combination of the following:
disposing a barrier layer comprising a multi-valent ionic retardant between an adhesive layer capable of activation by ultraviolet radiation and a substrate layer that, over time, releases multi-valent ionic species out of the substrate layer and into adjacent layers;
wherein the multi-valent retardant consists of at least one selected from an acrylic or acrylic copolymer (e.g., styrene acrylic copolymer) emulsion, a polyethylene waxed-based emulsion, an ethylenediaminetetraacetic acid or a derivative thereof, a polyfunctional aziridine-based cross linker, a polyurethane emulsion, a carboxylated styrene butadiene rubber or non-carboxylated styrene butadiene rubber emulsion, and a polyvinyl acetate or polyvinyl acetate copolymer (e.g., poly(vinyl alcohol) stabilized vinyl acetate-ethylene) emulsion;
wherein the substrate comprises paperstock;
wherein the multi-valent ionic species comprises calcium ions;
wherein the multi-valent retardant comprises a chelating agent; and
wherein the multi-valent retardant comprises a hydrophobic polymer.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The inventors have observed a loss of tack and general degradation of adhesive performance in UV-cured adhesives that are coated onto paperstocks (either directly or indirectly, via transfer coating on the liner and other similar approaches) after prolonged periods of time. Curiously, a similar loss of tack is not observed in UV adhesives coating onto polymeric films. While not intending to be bound by any theory of operation, the inventors discovered that calcium and/or other ions migrating from the paper/substrate or from other components within the label (e.g., titanium ions from pigments, ions from emulsions, etc.) appear to interfere with the UV adhesive performance.

Accordingly, a barrier layer is contemplated to partially or completely separate any coated UV adhesive from a calcium-containing and/or other ionic-containing facestock and materials (and particularly multivalent ions commonly found in such materials). The barrier layer (or a series of layers) is positioned within a multi-layer sheet so as to protect the adhesive layer by preventing migration from the suspected and aforementioned multi-valent ionic sources (e.g., paper substrates, emulsions, etc.). An optional release liner may be applied over the adhesive, on its opposite side from the facestock, to create label stock for use as is common in this field. A plurality of labels can be formed in such label stock through the use of perforations, dye cuts, deadeners, and the like. In the same manner, patterns and selective coating techniques may be employed for the adhesive and/or barrier layer, along with any of the other optional items mentioned herein.

In some embodiments, a chelating material may be incorporated into the barrier layer. For example, tetrasodium ethylenediaminetetraacetate (CAS no. 64-02-8) is particularly useful. Notably, it selectively coordinates with multivalent ions such as iron, copper, manganese, calcium, magnesium, and zinc, while avoiding chelation of monovalent metals such as sodium or potassium. It is also useful owing to solubility and miscibility in water, and it maintains its stability as a chelating agent over a comparatively large range of temperatures and pH levels. These exemplary characteristics may also be found in other chelators, such that combinations of these materials can be incorporated into formulations under certain embodiments contemplated herein.

Binders, pigments, and/or inks may be mixed with the chelating material in some embodiments. These additional items will provide for a larger range of aesthetic and functional uses of the barrier layer.

In each instance, the barrier layer is disposed at an effective distance from the UV-cured adhesive(s) to ensure migration of unwanted ions, and particularly calcium ions and/or other multi-valent ions, is arrested. Thus, a sufficient amount of chelator can be determined based upon the ionic content of the paperstock/substrate that is used.

To improve efficacy, the barrier layer is disposed between the adhesive and the paperstock/substrate along all points where the two come into contact. To the extent adhesive is selectively positioned on only portions of the paperstock/substrate, the barrier layer should be positioned correspondingly. In a similar manner, if the label consists of a plurality of layers (beyond paperstock and an adhesive), the barrier is positioned between the salient layers, preferably adjacent to the paperstock/substrate.

Notably, because the invention is premised upon arresting the unwanted migration of multi-valent ions from a substrate having such ions, a chelating material is not necessarily essential to certain embodiments. In the alternative or in addition to the use of a calcium and/or multi-valent ionic chelator, it may be possible to simply provide a barrier composition having hydrophobic properties based upon common polymers. Such hydrophobic polymeric layers block or otherwise sufficiently prevent calcium and other ions from migrating through the polymeric layer so as to retain the functionality of the adjacent UV adhesive well beyond the period of time shown by both control groups and polymeric layers formulated to have a hydrophilic nature.

Preferred chelators include ethylenediaminetetraacetic acid and derivatives based thereon, owing to its availability and cost. However, other common or useful chelating agents could be used in addition to or in place thereof.

Preferred hydrophobic polymer layers include emulsions based on acrylic, acrylic copolymers (e.g., styrene acrylic copolymer), polyvinyl acetate, polyvinyl acetate copolymers (e.g., poly(vinyl alcohol) stabilized vinyl acetate-ethylene), and/or polyethylene wax. Additional materials in this regard include polyfunctional aziridine-based cross linkers, polyurethane emulsions, and/or carboxylated styrene butadiene rubber or non-carboxylated styrene butadiene rubber emulsions. As noted above, other hydrophobic films may also be possible.

The coating weight for the barrier layer can vary, so long as a continuous film is formed along all the desired and salient parts of the substrate or adhesive layer. Weights between 2.5 and 10 grams/square meter (gsm) are desired. Steps should also be taken to minimize the amount of ionic species present in the barrier layer and/or the substrate and other layers in proximity to the adhesive layer. As a non-limiting example, deionized water can be used in the formulation and manufacturing processes.

As demonstrated by the examples below, the inventors focused on loop tack adhesion (e.g., ASTM D6195) as a performance indicator for the coatings contemplated in this disclosure. Nevertheless, additional measures of adhesive quality and performance can also be employed.

A method of prolonging adhesives in labelstocks through the use of a barrier layer is also contemplated. Here, an ionic migratory retardant is provided during or after the manufacture of the label. One or more barrier coatings may be applied to the paperstock, to the adhesive, or to a release liner which is subsequently transferred onto the desired location (i.e., between the adhesive and the paper).

A series of formulations relying on various compositions, some including chelating materials, were tested in comparison to a control group in which the UV adhesive was coated directly onto the paperstock. Tables 1-5 below provide additional details about the compositions and relative performance of the barrier coatings so tested. Notably, while specific examples of paper types are identified, it will be understood that the vast majority of paperstocks currently available possess sufficient levels of migrating, multi-valent ionic species so as to be candidates as substrates in need of the inventive barrier layer. Thus, ordinary copy papers, brown and other craft papers, and standard paperstocks are all possible substrate types, in addition to the specific types of paper referenced in the Tables below and, to the extent any tradename for a label or material stock is identified, it should be understood as a reference to the paperstock substrate within that line of products.

In the same manner, all of the other specific examples of materials provided in association with the foregoing tables are merely exemplary. A skilled person will understand that the characteristics identified in these materials (e.g., chemical composition, tolerances for impurities, etc.) are representative. Thus, it is possible to identify any number of substitutes for these materials, based upon their known characteristics, without departing from the principles of the inventions contemplated herein and/or the appended claims.

Lastly, the disclosures in each table should be understood to encompass any and all ratios and percentages of materials or groupings of materials relative to the entire formulation and/or relative to other specific materials or groupings of materials. Further, the tables and common materials identified in each example may be interpreted collectively so as to create and encompass upper and lower ranges, as well as averages, for that material even if the value is not specifically provided.

TABLE 1
Lab Samples by coating on TB paper, aging results

| | | | | | | | | | Coat | Loop Tack (Newton) | | | | |
|---|---|---|---|---|---|---|---|---|---|---|---|---|---|---|
| | Joncryl | | | Vinnapas | | EDTA | | | weight | Week of aging* | | | | |
| Example | 1907 | 95 | 1522 | 323 | 400 | Versene*** | Versene 100 | Water | gsm | Initial | 1 | 2 | 3 | 4 |
| Control | | | | | | | | | | ST** | 0 | 0 | 0 | 0 |
| 1 | 100 | | | | | | 24 | 20 | 5 | ST | ST | ST | ST | 4 |
| 2 | 100 | | | | | | 24 | 20 | 10 | ST | ST | ST | 1 | 0 |
| 3 | 100 | | | | | | 48 | 27.6 | 5 | ST | 2 | 2 | 0 | 0 |
| 4 | 100 | | | | | | 48 | 27.6 | 10 | ST | 1 | 1 | 0 | 0 |
| 5 | 100 | | | | | | 16.8 | 20 | 5 | ST | ST | ST | 2 | 1 |
| 6 | 100 | | | | | | 16.8 | 20 | 10 | ST | ST | ST | 8 | 8 |
| 7 | 95 | | | | | | | 9.5 | 5 | ST | ST | ST | 3 | 1 |
| 8 | 95 | | | | | | | 9.5 | 10 | ST | ST | ST | ST | 8 |
| 9 | | | | | 100 | 11 | | 30 | 5 | ST | ST | ST | 1 | 0 |
| 10 | | | | | 100 | 11 | | 30 | 10 | ST | ST | ST | 2 | 2 |
| 11 | | | | 100 | | 11 | | 30 | 5 | ST | ST | 7 | 0 | 0 |
| 12 | | | | 100 | | 11 | | 30 | 10 | ST | 10 | 11 | 1 | 0 |
| 13 | | | | 100 | | | | 30 | 5 | ST | 6 | 8 | 0 | 0 |
| 14 | | | | 100 | | | | 30 | 10 | ST | ST | 13 | 3 | 0 |
| 15 | | | | | 100 | | | 30 | 5 | ST | ST | ST | 1 | 0 |
| 16 | | | | | 100 | | | 30 | 10 | ST | ST | ST | 0 | 0 |
| 17 | | | | | 100 | 22 | | 30 | 5 | ST | ST | 4 | 0 | 0 |
| 18 | | | | | 100 | 22 | | 30 | 10 | ST | ST | ST | 0 | 0 |
| 19 | | | | 100 | | 22 | | 30 | 5 | ST | 7 | 4 | 0 | 0 |
| 20 | | | | 100 | | 22 | | 30 | 10 | ST | ST | 6 | 0 | 0 |
| 21 | 100 | | | | | | 12 | 20 | 5 | ST | ST | ST | 2 | 1 |
| 22 | | 90 | | | | | | 10 | 5 | ST | 4 | 7 | 8 | 5 |
| 23 | | 90 | | | | | | 10 | 10 | ST | ST | ST | ST | ST |
| 24 | | | 90 | | | | | 10 | 5 | ST | 5 | 8 | 8 | 5 |
| 25 | | | 90 | | | | | 10 | 10 | ST | ST | ST | ST | 11 |

*aging under 50° C./90% relative humidity
**ST = Sample Tear
***Versene ammonium EDTA

TABLE 2
Pilot Samples coating on TB base paper, aging results

| | | | | | | Loop Tack (Newton) | | | | |
|---|---|---|---|---|---|---|---|---|---|---|
| | Joncryl | EDTA | Polyaziridine | | Coat weight | Week of aging* | | | | |
| Example | 1907 | Versene 100 | CX-100 | Water | gsm | Initial | 1 | 2 | 3 | 4 |
| 26 | 95 | | | 9.5 | 4.5 | ST | ST | ST | 10 | ST |
| 27 | 95 | | | 9.5 | 9 | ST | ST | ST | ST | ST |
| 28 | 100 | 24 | | 20 | 4.5 | ST | 2 | 5 | 4 | 6 |
| 29 | 95 | | 0.9 | 9.5 | 4.5 | ST | ST | ST | 10 | 12 |
| 30 | 95 | | 0.9 | 9.5 | 9 | ST | ST | ST | ST | ST |

*aging under 50° C./90% relative humidity
**ST = Sample Tear

TABLE 3
Barrier coat with pigment on 61# Glatfelter paper in the lab and pilot

| | | | | Barrier layer | Loop Tack (Newton) | | | | |
|---|---|---|---|---|---|---|---|---|---|
| | Joncryl | Polyaziridine | | Coat weight | Week of aging* | | | | |
| Example | 1907 | CX-100 | Water | gsm | Initial | 1 | 2 | 3 | 4 |
| 31 | 95 | | 9.5 | 0 | 18 | 8 | 4 | 9 | 7 |
| 32 | 95 | | 9.5 | 5 | 8 | 16 | 8 | 17 | 16 |
| 33 | 95 | | 9.5 | 10 | 14 | 22 | 7 | 17 | 16 |
| 34** | 95 | 0.9 | 9.5 | 5 | 13 | 13 | 5 | 8 | 10 |

*aging under 50° C./90% relative humidity
**by pilot coater

TABLE 4
Barrier coat on 61# Glatfelter paper by UV ink Printing

| | | | | Loop Tack (Newton) | | | | |
|---|---|---|---|---|---|---|---|---|
| Exam- | UV ink (BCM) | | | Week of aging* | | | | |
| ple | White** | Grey 1*** | Grey 2**** | Initial | 1 | 2 | 3 | 4 |
| 35 | 12 | 7 | | 20 | 25 | 18 | 14 | 7 |
| 36 | 12 | | 7 | 14 | 17 | 12 | 11 | 13 |
| 37 | 12 | | | 13 | 9 | 11 | 10 | 5 |

*aging under 50° C./90% relative humidity
**White ink by Flint group, UEF9-0100-362U
***Grey ink by Flint Group, UEF 80109
****Grey ink by Flint Group,

TABLE 5
Other Polymer Types coating on TB base paper, aging results

| | | | | | Coat | Loop Tack (Newton) | | | | | | |
|---|---|---|---|---|---|---|---|---|---|---|---|---|
| | | Polymer | Formulation (gm) | | weight | Week of aging* | | | | | | |
| Example | Material*** | Type | Emulsion | Water | gsm | Initial | 1 | 2 | 3 | 4 | 6 | 8 |
| 38 | UD-104 | PU | 200 | 15 | 6.7 | 13 | 15 | 14 | ST | ST | ST | ST |
| 39 | UD-255 | PU | 200 | 15 | 3.7 | ST | ST | ST | ST | ST | ST | ST |
| 40 | Tykote1005 | Carboxylated SBR | 200 | 20 | 7.1 | ST | ST | ST | ST | ST | ST | ST |
| 41 | Rovene 4040 | non-calboxylated | 200 | 15 | 6 | ST | 13 | 11 | 13 | 12 | 10 | 7 |
| | | SBR | | | | | | | | | | |
| 42 | Rovene 4100 | Carboxylated SBR | 200 | 15 | 5.5 | ST | ST | ST | 15 | 15 | ST | 15 |
| 43 | Resyn 1190 | PVAc | 200 | 15 | 4.8 | ST | ST | ST | ST | ST | 9 | 5 |

*aging under 50° C./90% relative humidity
**ST = Sample Tear

With further reference to the Tables, control adhesive was applied directly to onto the back side of True Block-type (TB) paper such as 60# uncoated (produced by Neenah, with spec #7389P0) by using a 100HK Gravure plate (for Tables 1, 2 and 5) or Glatfelter-type paper such as 61# D93 (PH Glatfelter with spec #319423; Pixelle Enhance HiBrite) (for Tables 3 and 4). The coated paper was then dried for 5 minutes at 100° C. One layer of coating is about 5 g/m² (gsm), unless noted to the contrary. Also unless noted to the contrary, formulation amounts are provided in grams, while the loop tack results are in Newtons, reflecting the maximum force to remove the loop unless the sample tore (refer to ASTM D6195). Also, it should be understood that sample tears (ST) verify that the adhesive is functioning as intended.

Example 1, as well as companion Examples 2-25 (which contain slight variations to the formulation), were prepared by charging the stated amount of Joncryl (from BASF) and/or Vinnapass (from Wacker Chemie) to a container under light mixing. Versene or Versene 100 EDTA (both from Dow Chemical) and variable amounts of water were add until the mixture had a final viscosity of about 100 cps. Notably, Joncryl 1907 and 1522 are film forming and acrylic emulsions, while Joncryl 35 is a polyethylene based wax emulsion. Vinnapas 323 and 400 are poly(vinyl alcohol) (PVA) stabilized vinyl acetate-ethylene copolymer dispersions. Table 1 indicates the precise formulation for each Example.

Each example was then printed onto the back side of TB paper by using a 100HK Gravure plate. The coated paper was then dried for 5 minutes at 100° C. One layer of coating is about 5 gsm.

Each of the aforementioned papers were then coated with 20 gsm of UV adhesive acResin A250 (from BASF). The resulting coated structure was cured at 20 mj/cm² UVC dosage with one pass. The adhesive coated paper was then put in the oven of 50° C.@90% relative humidity (RH) for aging study. The loop tack of the aged samples was then determined on stainless steel by Instron at 12 inches/minute. The results are summarized in Table 1.

Generally speaking, the control performed unacceptably after just one week of high temperature-high humidity (i.e., 50° C. and 90% relative humidity). Virtually all of the samples with barrier coating(s), whether the acrylic or wax-based emulsions (Joncryl), the PVA stabilized vinyl acetate ethylene copolymers (Vinnapass), and/or the chelating agents (Versene), outperformed the control. Further, some of the formulations with low amounts of water (e.g., less than about 25 wt. %, less than about 15 wt. %, or less than about 10 wt. % of the total formulation but greater than about 5 wt. %) can perform better under certain circumstances, while the addition of EDTA and heavier coating weights (e.g., greater than 2.5 gsm, greater than 5 gsm, and greater than 10 gsm, but less than 50 gsm) for the adhesive also tended to improved performance. However, the use of de-ionized (DI) water may be equally significant, with DI water and/or emulsions with low levels of multi-valent ionic species expected to also perform better than materials created without regard to potential ionic species

Examples 26 to 30 which were produced by the pilot coater according to the indicated formulations in Table 2. Polyaziridine CX-100 (from PolyAziridine LLC) is a polyfunctional aziridine-based cross linker. All coatings on the pilot were run at 70 fpm with 100HK gravure cylinder and dried in a 3 zones oven at temperature of 200° F., 210° F., 240° F. Each zone is 5 feet. Generally speaking, the pilot samples performed better than the laboratory samples of Table 1. Here, lower use of water and/or heavier coating weight seemed to improve performance in some instances.

Example 31 in Table 3 explored the use of pigments, such as titanium dioxide, in the barrier coating. A first formulation was charged to a container along with 173.3 gm of TiO₂ slurry (WWT10000S60, produced by American Colors), under light mixing. Then the stated amounts of Joncryl 1907, along with 2.7 gm of Surfynol DF-75 (by Air Products), 2.7 gm of BYK381 (by Altana group), and 27 gm of isopropyl alcohol, and 52 gm of water were added. A second formulation was made in a separate container by charging 173.3 gm of WWT10000S60, under light mixing, then add 100 gm of Joncryl 1907, 1.7 gm of black dispersion slurry (WWT80002, produced by American Colors), 2.7 gm of Surfynol DF-75, 2.73 gm of BYK 381, 27 gm of isopropyl alcohol, and 52 gm of water.

Taking Glatfelter paper, 5 gsm of the first formulation and then 10 gsm (print twice) of second formulation were printed on the back side, resulting a coated paper which has L* 92.4, a* −0.75 and b* −3.15 at 99.8 opacity.

The UV adhesive coated sample was then aged in oven at 50° C.@90% RH. The aged results indicate that the barrier layer containing TiO₂ can perform much better than the control sample.

Example 32 was created based on the coated paper from Example 31, but with 5 gsm of the example 8 formulation coated thereto. Likewise, Example 33 coated 10 gsm of Example 8 onto a base formed by Example 31. These added layers improves the performance.

Example 34 followed Example 29 in formulation, except the base paper is 61# D93 based paper produced by PH Glatfelter. The UV adhesive coated paper of Samples 31-34 were aged 4 weeks and the results are in Table 3. Each formulation retained tack over the course of testing.

In Table 4, instead of using TiO₂ slurry to coat on Glatfelter paper, to increase the paper opacity, the backside of the Glatfelter paper was printed with 12 BCM white UV ink (by Flint Group, UEF-9-0100-362U) and 7 BCM grey UV ink (by Flint Group, UEF 80109) to produce Example 35. Example 36 was the same as Example 35, but the base paper was printed with 12 BCM white UV ink (by Flint Group, UEF-9-0100-362U) and 7 BCM grey UV ink (will provide info after knowing the UEF#). Lastly, Example 37 was also the same as Example 35, the base paper was printed with only 12 BCM white UV ink. Here again, all coating with the inventive barrier coating performed better than the control.

Similar to the procedures provided for Tables 1 and 2, Table 5 shows other polymer type coatings on TB paper that may be appropriate for use as a barrier layer/coating in accordance with certain aspects of the invention. Here, polyurethane (PU) provided by Bond Polymer, carboxylated and non-carboxylated styrene butadiene rubber (SBR) from Mallard Creek Polymers, and polyvinylacetate from Celanese were considered.

While all of the materials shown in Table 5 performed quite well on the loop tack testing, loss of peel adhesion after 8 weeks was observed of the polyvinyl acetate. However, each of the materials performed much better than the control sample shown in Table 1 (which is, of course, comparable owing to the similarities in testing conditions for Tables 1, 2, and 5).

A final, real world control was also conducted, although these results are not reflected in any of the aforementioned tables. Two wine bottle labels, Estate #8 and Classic Crest Solar White paper (from Neenah Paper), were coated with UV adhesive, after aging 14 days at 23° C.@50% RH, the quick stick on glass were 11.38 and 10.48 Newton, respectively. For the same labels, after aging 7 days at 50° C.@90% RH and then 7 days at 23° C.@50% RH, the quick stick on glass were dropped to 0.25 and 0.36 Newton respectively. Thus, without a barrier coating, the UV adhesive on these wine bottle labels did not perform well.

In view of the foregoing, The aged results suggest that the paper stock needs a barrier layer either by coating or printing to have long term good adhesive properties as a label when using UV-cured adhesive. The barrier layer can be a binder by itself or pigmented coating or inks. Without a barrier layer, it was believed that the calcium and/or other multi-valent ions in the paper migrates to the adhesive layer to kill the tack of the UV adhesive after aging only 2 weeks under 50° C./90% RH.

More generally, the barrier layer can be positioned proximate to a substrate (such as common paperstocks) which emits/allows migration of multi-valent ionic species out of the substrate and/or proximate to an emulsion that is formulated with water or other materials likely to have such multi-valent species. In this manner, the unwanted migration of the multi-valent species is apprehended by the barrier layer, and the UV-cured adhesive within the sheet is preserved and/or its shelf-life significantly prolonged. The use of low-ionic-containing materials (e.g., in the emulsions), as well as the use of deionized water, during the formulation of components for the sheet further enhance these aims.

Other structures and features may be discerned from this disclosure and the attached drawings. By way of example rather than limitation, these features may include dimensions and relative proportions and/or ratios of the various components. In the same manner, certain ornamental features may augment the utilitarian functions of the disclosure.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The features of each embodiment described and shown herein may be combined with the features of the other embodiments described herein. The claims as follows are intended to include all modifications and alterations insofar as they come within the scope of the claims or the equivalent thereof.

Having thus described the invention, I claim:

1. A sheet including adhesive to allow at least a portion of the sheet to be affixed to an object, the sheet comprising:
an adhesive layer cured with ultraviolet radiation;
a substrate layer positioned on an outer facing of the sheet, said substrate layer containing at least one multi-valent ionic species which migrates out of the substrate layer; and
a barrier layer interposed between the adhesive layer and the substrate layer at all points where the adhesive layer would otherwise come into direct physical contact with the substrate layer, said barrier layer including a substance to apprehend migration of the multi-valent ionic species before the multi-valent ionic species comes into contact with the adhesive layer.

2. The sheet according to claim 1 wherein the multi-valent ionic species includes calcium ions.

3. The sheet according to claim 1 wherein the substance is chelating agent.

4. The sheet according to claim 1 wherein the substance is a hydrophobic polymer.

5. The sheet according to claim 1 wherein the substance is at least one selected from an acrylic or acrylic copolymer emulsion, a polyethylene waxed-based emulsion, an ethylenediaminetetraacetic acid or a derivative thereof, a polyfunctional aziridine-based cross linker, a polyurethane emulsion, a carboxylated styrene butadiene rubber or non-carboxylated styrene butadiene rubber emulsion, and a polyvinyl acetate or polyvinyl acetate copolymer emulsion.

6. The sheet according to claim 5 wherein the barrier layer is formulated with deionized water.

7. The sheet according to claim 1 wherein the barrier layer is formulated with deionized water.

8. The sheet according to claim 5 wherein the barrier layer is coated at a weight of between 2.5 and 10.0 grams per square meter.

9. The sheet according to claim 1 wherein the barrier layer is coated at a weight of greater than 10.0 grams per square meter.

10. The sheet according to claim 1 wherein the substrate layer consists of paperstock having a multi-valent ionic species.

11. The sheet according to claim 1 wherein the sheet includes at least one of: a pigment and an ink activated by ultraviolet radiation.

12. The sheet according to claim 1 wherein a release liner is applied to the adhesive layer.

13. The sheet according to claim 1 wherein the barrier layer is applied directly to the substrate layer.

14. The sheet according to claim 1 wherein the barrier layer is partially or intermittently applied to only portions of the sheet.

15. A method of prolonging a functional lifespan for an adhesive label cured by ultraviolet radiation, the method comprising:
disposing a barrier layer comprising a multi-valent ionic retardant between an adhesive layer capable of activation by ultraviolet radiation and a substrate layer that, over time, releases multi-valent ionic species out of the substrate layer and into adjacent layers.

16. The method of claim 15 wherein the multi-valent retardant is at least one selected from an acrylic or acrylic copolymer emulsion, a polyethylene waxed-based emulsion, an ethylenediaminetetraacetic acid or a derivative thereof, a polyfunctional aziridine-based cross linker, a polyurethane emulsion, a carboxylated styrene butadiene rubber or non-carboxylated styrene butadiene rubber emulsion, and a polyvinyl acetate or polyvinyl acetate copolymer emulsion.

17. The method of claim 15 wherein the multi-valent ionic species comprises calcium ions.

18. The method of claim 15 wherein the substrate comprises paperstock.

19. The method of claim 18 wherein the multi-valent retardant comprises at least one of a chelating agent and a hydrophobic polymer.

20. The method of claim 18 wherein the multi-valent retardant comprises a hydrophobic polymer.
